(19) United States
(12) Patent Application Publication
(10) Pub. No.: US 2003/0012435 A1
(43) Pub. Date: Jan. 16, 2003

(54) Apparatus and method for machine vision

(75) Inventor: James Forde, Eagan, MN (US)

Correspondence Address: MERCHANT & GOULD PC, P.O. BOX 2903, MINNEAPOLIS, MN, 55402-0903, US

(73) Assignee: DataCard Corporation, Minnetonka, MN (US)

(21) Appl. No.: 10/174,051

(22) Filed: Jun. 17, 2002

Related U.S. Application Data
(60) Provisional application No. 60/298,819, filed on Jun. 15, 2001.

(51) Int. Cl. G06K 9/00

(52) U.S. Cl. 382/167

(57) ABSTRACT

An apparatus and method for evaluating an image. In the method, an image is obtained in HSV format, the color is determined, an artifact is identified in the image based on the color, and an output is produced based on the artifact. The artifact may include the image. The image may also be modified prior to output. The method may include obtaining a base image, and comparing the color of the base image to the color of the image to identify artifacts. The apparatus includes an imager for generating an image, a processor for distinguishing artifacts in images based on color, and an output device such as a video monitor, hard disk, or identification card printer. The apparatus may also include additional imagers and processors. One particular application of the invention is for cropping an image having a face therein to a leave only a portion showing the face.

This application claims the benefit of U.S. Provisional Application No. 60/298,819, entitled APPARATUS AND METHOD OF CROPPING FACIAL IMAGES, filed Jun. 15, 2001, and is incorporated herewith by reference in its entirety.

### BACKGROUND OF THE INVENTION

This invention relates to an apparatus and method for machine vision. More particularly, the invention relates to the automatic identification of artifacts in still and video images, and to modifying images based on the presence of those artifacts. One exemplary application of the invention is for cropping images that include a face to an area substantially limited to the face only. This may be particularly useful when cropping such images as part of a process of manufacturing cards, such as identification cards.

A wide variety of imagers are in conventional use. Commonly, imagers are used to generate a still or video image of a particular object or phenomenon. The object or phenomenon then appears as an artifact within the image. That is to say, the object or phenomenon itself is of course not present in the image, but a representation of it—the artifact—is.

For many applications, such as those wherein a large number of images are to be generated, or those wherein it is desired that images be generated with a high degree of consistency, it may be advantageous to generate images automatically. However, this poses technical problems.

For example, one artifact that is commonly generated in images is an artifact of the human face. Facial images (artifacts) are used in a wide variety of applications. As faces are easily distinguished and identified by humans, facial images are commonly used in various forms of identification card.

An exemplary identification card 40 is illustrated in FIG. 1. The card 40 includes an image 42, showing a person's face 44. The card also includes indicia 46. Indicia may include information such as the card-holder's name, department, employee number, etc.

Identification cards are typically small, on the order of several inches in width and height. Thus, the area available for a photograph is limited. In order to make maximum use of the available area, it is often preferable to arrange for the face to fill or nearly fill the entire space allotted to the image. In addition, it is often preferred that the photographs be of standard size on all cards of a particular type.

It is, of course, possible to use specialized cameras that generate appropriately sized photographs. It is likewise possible to arrange the conditions under which the photograph is taken so that the faces of the various persons being photographed are correctly sized and properly positioned within the area of the photograph. This can be done, for example, by arranging the camera at the proper distance from the subject, and by aiming it at the proper height to capture the subject's face, and only their face. However, the heights of different subjects faces varies greatly, i.e. due to youth, normal variation, use of a wheelchair, etc. In addition, the relative size of a subject's face in a photographic image depends on both the distance and the optical properties of the camera itself. As a result, efforts to produce photographs that inherently have the proper size and configuration are time consuming and prone to errors, and moreover require the services of a skilled photographer.

Thus, it is desirable to obtain larger photographs, and subsequently crop (trim) them to the proper size, with the subject's face filling the remaining image.

However, although humans can easily identify a face in an image, machines are much less adept at this task. Although attempts have been made to create automated methods of recognizing faces, in particular by use of computer software, conventional methods suffer from serious limitations. Known methods often are often slow, and are prone to errors in identifying faces. In addition, known methods are often extremely complex and difficult to use. Furthermore, known methods commonly require specialized equipment, and are consequently very expensive

As a result, it has been common to crop facial images manually. Typically, this involves either actually trimming a physical photograph, i.e. with scissors or a blade, or electronically trimming a virtual photograph using software. Both operations require considerable time, and a relatively high degree of training.

Likewise, it is generally difficult to automate image identification and processing tasks for applications other than facial photography, for similar reasons. Namely, while identifying objects and patterns in relatively simple for a human observer, it is extremely difficult for conventional automated systems. Thus, machine vision and tasks that depend upon machine vision is conventionally difficult, expensive, and unreliable.

### SUMMARY OF THE INVENTION

It is therefore the purpose of the claimed invention to provide an apparatus and method for machine vision, also referred to herein as image evaluation, in particular for the identification of artifacts within still or video images.

In general, a method of image evaluation in accordance with the principles of the claimed invention includes the step of obtaining an image in HSV (Hue-Saturation-Value) format. The color of at least a portion of the image is determined automatically. An artifact is then automatically identified within the image based at least in part on the color of the artifact and the color of the remainder of the image (the remainder being referred to at some points herein as “the background”). An output of some sort is then produced once the artifact is identified.

The output may include some or all of the image itself, typically including at least part of the artifact.

The method may also include various automatic modifications to the image. For example, the image may be cropped, scaled, or reoriented. The color of the artifact and/or the background may be modified. The background may even be replaced or removed altogether.

The output may also include instructions for obtaining further images. For example, the output may provide cues for adjusting an imager with regard to focus, alignment (i.e. “aim point”), color balance, magnification, orientation, etc. Thus, the image evaluation method may be utilized in order to calibrate an imager for further use.

A method in accordance with the principles of the claimed invention may also include the steps of obtaining a base image. The color of at least part of the base image is compared automatically with the color of at least part of the image, and the artifact (or artifacts) therein are identified at least in part from the color of the base image.

An apparatus in accordance with the principles of the claimed invention includes a first imager for generating a color first image, in HSV format. A first processor is connected with the first imager. The first processor is adapted to distinguish a first artifact in the first image from the remainder of the first image automatically, based at least in part on the color of the artifact and the remainder. The apparatus also includes an output device.

The first image may be a video imager, and the first image may be a video image.

The output may include at least a portion of the first artifact.

Alternatively, the apparatus may also include a second imager, adapted to generate video images, and a second processor connected to the first and second imagers. In such a case, the first imager may be a still imager, and the first image a still image.

In such an arrangement, the second processor distinguishes a second artifact in the second image, based at least in part on the color of the artifact and the remainder of the second image. Once the second artifact is identified, the second processor signals the first imager to generate the first image.

In other words, the second imager (a video imager) is used to “watch” for an artifact (i.e. a face), and when the artifact is identified, the first imager (a still imager) is used to generate an image for output purposes.

In such an arrangement, the first processor need not be adapted to receive the second image. Rather, only the second processor need receive and process the second image. This may be advantageous for certain embodiments.

The second processor and the second imager may form an integral unit, with the second processor being a dedicated imaging processor. Such an integral unit might then be connected as an external device to a personal computer, which would then function as the first processor. Because the first processor (in this case a personal computer) does not need to receive the second (video) image from the second imager, it is possible to use an inexpensive, “low-end” personal computer or similar processor.

Of course, it is possible for the first processor to be connected with the second imager and to receive a video signal therefrom. However, while a dedicated second processor for processing a video image can be made simply and inexpensively, a general-purpose first processor such as a personal computer that is capable of handling the same video image is conventionally complex and expensive.

The first imager may be a digital still camera, and the second imager may be a digital video camera.

The output device may include a variety of mechanisms, including but not limited to a database system, a video display such as a computer monitor, a conventional printer, a card printer for printing identification cards, or a recording device such as a hard drive, CD drive, etc.

Throughout this description, the invention is often described with respect to an exemplary application, that of automatically cropping an image with an artifact of a human face therein to a predetermined size and arrangement. It is emphasized that this application is exemplary only. A wide variety of other applications and variations may be equally suitable.

However, for clarity, the invention is now described in terms of the concrete example of facial cropping.

An exemplary embodiment of a method for cropping facial images in accordance with the principles of the claimed invention includes the step of obtaining a base image. The base image is used to generate baseline information regarding background conditions, and does not include a human subject. The base image includes a plurality of pixels.

A region of interest within the base image is identified.

A plurality of base samples, each consisting of one or more pixels, are obtained from the base image. The color of each of the base samples is evaluated in HSV (hue-saturation-value) format. The HSV values for each of the base samples is then stored in an array.

A capture image is obtained, the capture image including the same area as the base image, and including the region of interest and a human subject whose face is within the region of interest. The capture image also includes a plurality of pixels.

A plurality of capture samples, each consisting of one or more pixels, are obtained from the base image. Each of the capture samples corresponds in terms of area and location to one of the base samples. The color of each of the capture samples is evaluated in HSV format.

The HSV value for each capture sample is compared to the HSV value for its corresponding base sample. Capture samples that have HSV values that do not match the HSV values of their corresponding base samples are identified. A cropped region of interest including adjacent capture samples with HSV values that do not match the HSV values of their corresponding base samples is assembled. The cropped region of interest is tested to exclude random errors by comparing the cropped region of interest to a minimum height and width. The cropped region of interest is thus an area of the capture image that is substantially different in color from the same area in the base image, and thus corresponds to the subject's face.

A portion of the capture image corresponding to the cropped region of interest is identified. The capture image is then cropped so as to yield a cropped image that retains at least a portion of this portion.

Optionally, the cropped image may include areas of the capture image that do not correspond to the cropped region of interest. For example, it may be desirable for certain applications to include a margin of otherwise empty background space around the subject's face.

Optionally, the cropped image may be modified in a variety of ways. For example, it may be scaled to fit a predetermined height and width or width and aspect ratio, or it may be aligned so that the face is centered or has a particular offset, etc.

An exemplary embodiment of an apparatus in accordance with the principles of the claimed invention includes an imager for obtaining images. The apparatus may be a digital still camera.

It also includes a processor in communication with the imager for processing the images. The processor is adapted to identify sample areas, to determine the color value of sample areas in HSV format, to generate an array of HSV values, and to compare HSV values to one another. The apparatus may consist of digital logic circuits, in particular a microcomputer.

The apparatus also includes at least one output device in communication with the processor. The output device is adapted to produce output from the processor in a useful form. The output device may include a hard drive, a card printer, or a video display screen.

### BRIEF DESCRIPTION OF THE DRAWINGS

Like reference numbers generally indicate corresponding elements in the figures.

FIG. 1 is a representation of an identification card as produced by a method or apparatus in accordance with the principles of the claimed invention.

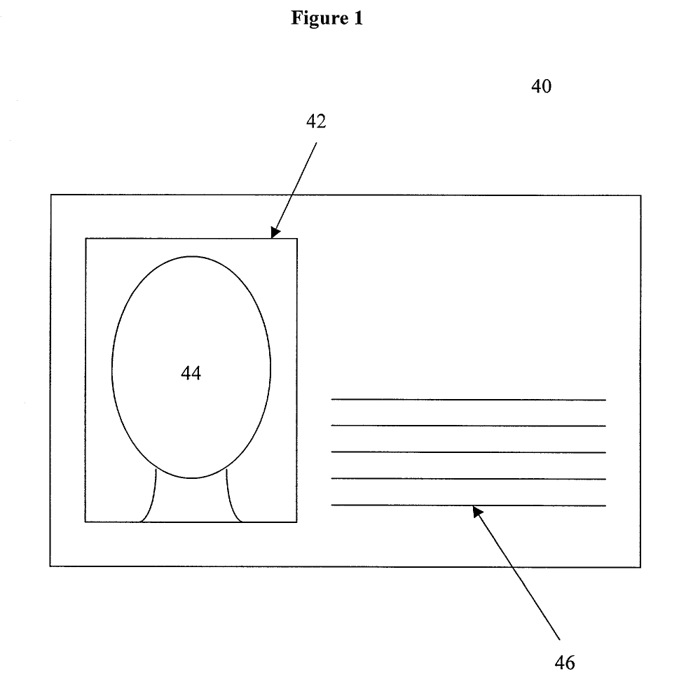

FIG. 2 is a schematic representation of an apparatus in accordance with the principles of the claimed invention.

FIG. 3 is a flowchart showing a method of cropping a facial image in accordance with the principles of the claimed invention.

FIG. 4 is a flowchart showing additional detail regarding the steps for determining the area and location of a face in an image, as shown generally in FIG. 3.

FIG. 5 is an illustration of an exemplary base image of a face, with a region of interest identified thereon.

FIG. 6 is an illustration of an exemplary distribution of base samples on the base image of FIG. 5.

FIG. 7 is in illustration of an exemplary capture image of a face, with an exemplary distribution of capture samples thereon corresponding to those in FIG. 6.

FIG. 8 is an illustration of an exemplary cropping operation as applied to the image of FIG. 6.

FIG. 9 is a schematic representation of another embodiment of an apparatus in accordance with the principles of the claimed invention.

FIG. 10 is a flowchart showing another method in accordance with the principles of the claimed invention.

FIG. 11 is a flowchart showing another method in accordance with the principles of the claimed invention.

### DETAILED DESCRIPTION OF THE PREFERRED EMBODIMENT

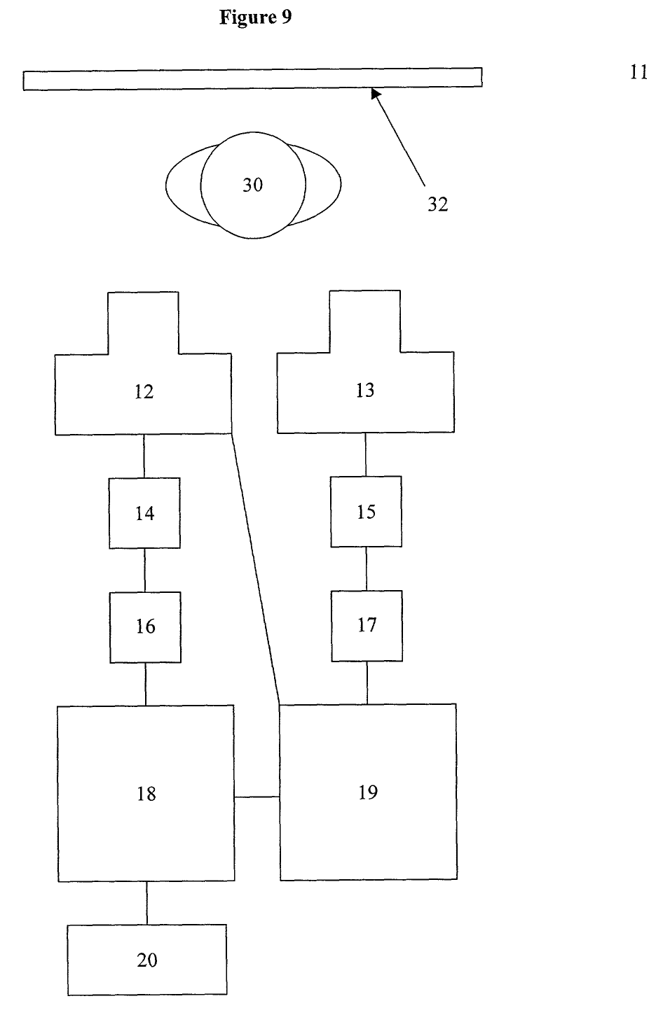

FIG. 9 shows an exemplary embodiment of an apparatus for machine vision in accordance with the principles of the claimed invention.

As a preliminary note, it is pointed out that FIG. 9 shows an apparatus having first and second imagers and first and second processors. However, this is exemplary only.

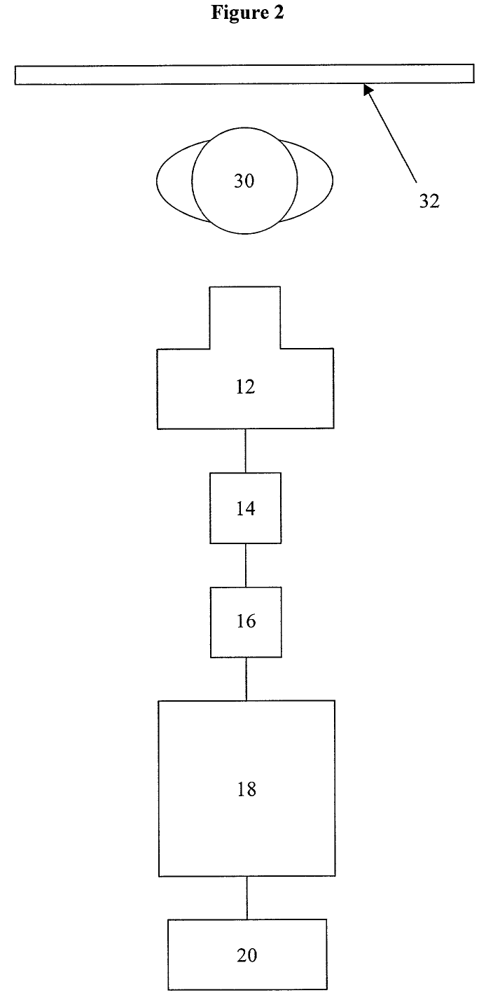

For example, FIG. 2 shows an apparatus having only a first imager and a first processor. Although FIG. 2 is described herein particularly with regard to the particular application of facial image cropping, the apparatus illustrated therein may be useful for other applications, and for machine vision in general.

Thus, it is emphasized that an apparatus in accordance with the principles of the claimed invention may have a single imager, first and second imagers, or a plurality of imagers, depending on the particular embodiment.

Similarly, it is emphasized that an apparatus in accordance with the principles of the claimed invention may have a single processor, first and second processors, or a plurality of processors, depending on the particular embodiment. In addition, it is noted that the number of processors need not necessarily be the same as the number of imagers. For example, an embodiment having two imagers may use only one processor.

Referring to FIG. 9, an apparatus for cropping images 11 in accordance with the principles of the claimed invention includes a first imager 12 and a second imager 13. The first imager 12 generates a first image, and the second imager 13 generates a second image.

Typically the first and second imagers 12 and 13 will have similar fields of view, so that images therein will be generated from approximately the same general area, and will thus contain the same subject(s) 30. However, it is not necessary that the first and second imagers 12 and 13 be precisely aligned so as to have completely identical fields of view. Their respective fields of view may be somewhat different in size and/or shape, and may be shifted somewhat with regard to vertical and horizontal position and angular orientation. Likewise, they may have somewhat different magnification, such that artifacts shown therein are not of exactly equal size. Precise equality between the first and second imagers 12 and 13, and the images and artifacts generated thereby, is neither necessary to nor excluded from the claimed invention.

In a preferred embodiment of the apparatus, the first imager 12 is a conventional digital video camera that generates digital video images, and the second imager 13 is a conventional digital still camera that generates digital still images. This is convenient, in that it enables easy communication with common electronic components. However, this choice is exemplary only, and a variety of alternative imagers, including but not limited to analog imagers, may be equally suitable. Suitable imagers are well known, and are not further described herein.

With regard to the term “video”, although this term is sometimes used to refer to a specific format, i.e. that used by common video cassette recorders and cameras, it is used herein to describe any substantially “real-time” moving image. A variety of possible formats may be suitable for use with the claimed invention.

In a preferred embodiment, the first and second imagers 12 and 13 generate images that are in HSV format. In such a format, a given color is represented by values for hue, saturation, and value. Hue refers to the relative proportions of the various primary colors present. Saturation refers to how “rich” or “washed out” the color is. Value indicates how dark or light the color is. HSV format is convenient, in that it is insensitive to variations in ambient lighting. This avoids a need for frequent recalibration and/or color correction of the imager 12 as lighting conditions vary over time (as with changes in the intensity and direction of daylight).

It is likewise convenient to generate the images in HSV format, rather than converting them from another format. However, this is exemplary only, and the first and second imagers 12 and 13 may generate images in formats other than HSV, including but not limited to RGB. The HSV format is well known, and is not further described herein.

The first imager 12 is in communication with a first processor 18. The first processor 18 is adapted identify a first artifact within the first image. The precise nature of the first artifact may vary considerably based on the subject being imaged. Suitable artifacts include, but are not limited to, faces, ID badges, vehicles, etc.

The first processor 18 is adapted to determine the color of at least a portion of the first image, and to distinguish first artifacts from the remainder of the first image based at least in part on color.

In a preferred embodiment, the first processor 18 consists of digital logic circuits assembled on one or more integrated circuit chips or boards. Integrated circuit chips and boards are well-known, and are not further discussed herein. In a more preferred embodiment, the first processor 18 consists of a dedicated video image processor. This is advantageous, for at least the reason that dedicated video image processors are readily available and inexpensive. However, this choice is exemplary only, and other processors, including but not limited to general purpose systems such as personal computers, may be equally suitable.

The first processor 18 is in communication with at least one output device 20. A variety of output devices 20 may be suitable for communication with the first processor 18, including but not limited to video monitors, hard drives, and card printers. Output devices are well-known, and are not further discussed herein.

The second imager 13 is in communication with a second processor 19. The second processor 19 is adapted identify a second artifact within the second image. As with the first artifact, the precise nature of the second artifact may vary considerably based on the subject being imaged. Suitable artifacts include, but are not limited to, faces, ID badges, vehicles, etc.

The second processor 19 is adapted to determine the color of at least a portion of the first image, and to distinguish second artifacts from the remainder of the second image based at least in part on color.

In a preferred embodiment, the second processor 19 consists of digital logic circuits assembled on one or more integrated circuit chips or boards. Integrated circuit chips and boards are well-known, and are not further discussed herein. In a more preferred embodiment, the second processor 19 consists of a commercial microcomputer such as a person computer. This is advantageous, for at least the reason that microcomputers are readily available and inexpensive. However, this choice is exemplary only, and other processors, including but not limited to dedicated integrated circuit systems, may be equally suitable.

As shown in FIG. 9, the second processor 19 is in communication with the first and second imagers 12 and 13. The second processor 19 is adapted to signal the first imager 12 when a second artifact has been identified in the second image, so that the first imager 12 generates a first image.

Thus, the second imager 13 monitors for a subject 30 using real-time video, and when one is identified, the first imager 12 generates a still image of the subject 30.

Such an arrangement is advantageous, for at least the reason that it permits real-time video monitoring of a subject 30 to be imaged, without the necessity of routing the large volume and high bandwidth of data the is required for a real-time video signal into the first processor 18. Instead, the first processor 18 need only handle still images from the first imager 12. However, as may be seen from FIG. 2 (described in more detail below), this arrangement is exemplary only.

As shown in FIG. 9, the communication between the second processor 19 and the first imager 12 may be direct, or it may be indirect, for example via the first processor 18, as is also illustrated.

In addition to identifying the second artifact, it may be advantageous for certain embodiments for the second processor 19 to be adapted to identify when the second artifact is no longer present in the second image.

For example, in an exemplary application wherein the apparatus 11 is used to generate facial images, once the second processor 19 has signaled the first imager 12 that a second artifact has been identified in the second image, and the first imager 12 has generated a first image, the second processor 19 may be adapted to wait until the second artifact is no longer present in the second image, and a new second artifact is identified, before signaling the first imager 12 again.

That is, the apparatus 11 may be adapted to identify the presence of the subject 30, generate a first image thereof, and then wait until the subject 30 leaves the field of view of the imagers 12 and 13 before generating another first image.

In this way, the apparatus 11 is useful for automatically and repeatedly generating a series of first images of various subjects 30. This may be advantageous for certain embodiments.

However, such an arrangement is exemplary only. In other embodiments, it may be advantageous for at least some of the operation of the apparatus to be manually controlled. For example, a “one-click” system of generating facial images, wherein an operator activates the system when a subject is sitting in the field of view of an imager (upon which the apparatus then generates the image(s) and automatically modifies and outputs them) may be equally suitable. Neither the claimed invention as a whole nor the automation of a particular feature of the invention excludes the option to manually control the invention or a part thereof.

Likewise, it is emphasized that although an apparatus in accordance with the claimed invention may be adapted to perform various functions automatically, this does not exclude these functions being performed manually, as by an operator. For example, even if an image is automatically cropped, scaled, color corrected, etc., it may still be modified manually by either further changing similar properties (i.e. recropping, resealing, etc.) or by changing other properties not automatically altered.

As noted above, it is preferable that the first and second imagers 12 and 13 generate digital images in HSV format. However, in an alternative embodiment, one or both of the first and second imagers 12 and 13 generate image that are not in HSV format, and the apparatus 11 includes a first and/or a second HSV converter 14 and/or 15 for converting images from a non-HSV format to HSV format. The first and second HSV converters 14 and 15 may consist of hardware or software integral to the first and second processors 18 and 19 respectively, or to the first and second imagers 12 and 13 respectively. This is convenient, in that it avoids the need for an additional separate component. However, this choice is exemplary only, and other HSV converters 14 and 15, including but not limited to separate, dedicated systems, may be equally suitable. HSV converters are well known, and are not further described herein.

In an additional alternative embodiment, the one or both of the first and second imagers 12 and 13 generates non-digital images, and the apparatus 11 includes first and/or second digitizers 16 and 17 in communication with the first and second imagers 12 and 13 respectively, and with the first and second processors 18 and 19 for converting images from a non-digital format to digital format. In a preferred embodiment, the digitizers 16 and 17 may consist of hardware or software integral to the processors 18 and 19, or to the imagers 12 and 13. This is convenient, in that it avoids the need for an additional separate component. However, this choice is exemplary only, and other digitizers 16 and 17, including but not limited to separate, dedicated systems, may be equally suitable. Digitizers are well known, and are not further described herein.

Although the elements of the invention illustrated in FIG. 9 (and FIG. 2) are shown as separate components for schematic clarity, this is exemplary only. Some or all of the components may be incorporated into integral assemblies.

In particular, in certain embodiments, the second imager 13 and the second processor 19 may be formed as part of an integral unit. This is particularly advantageous when the second processor 19 is a dedicated video processor. However, this is exemplary only, and other arrangements may be equally suitable.

It is noted that although two separate HSV converters 14 and 15 and two separate digitizers 16 and 17 are illustrated in FIG. 9, in certain embodiments the first and second imagers 12 and 13 may share a single HSV converter and/or a single digitizer.

It will be appreciated by those knowledgeable in the art that the although the imagers 12 and 13 by necessity must be located such that their field of view includes a subject 30 to be imaged, the processors 18 and 19, the output device 20, and the optional HSV converters 14 and 15 and digitizers 16 and 17 may be remote from the imagers 12 and 13 and/or from one another. As illustrated in FIG. 9, these components appear proximate one another. However, in an exemplary embodiment, the imagers 12 and 13 could be placed near the subject 30, with some or all of the remaining components being located some distance away. For example, for certain applications, it may be advantageous to connect the imagers 12 and 13 to a network that includes the processors 18 and 19 and the output device 20. Alternatively, the imagers 12 and 13 may be an arbitrary distance from the other components of the apparatus 11.

It is also pointed out that any or all of the connections between components may, for certain embodiments, be wireless connections. Wireless connections are well-known, and are not described further herein.

It will also be appreciated by those knowledgeable in the art that an apparatus in accordance with the principles of the claimed invention may include more than one first imager 12 and one second imager 13. Although only one set of first and second imagers 12 and 13 is illustrated in FIG. 9, this configuration is exemplary only. A first processor 18, second processor 19, and output device 20 may operate in conjunction with multiple sets of first and second imagers 12 and 13. Depending on the particular application, it may be advantageous for example to switch between sets of imagers 12 and 13, or to process images from multiple imagers 12 and 13 in sequence, or to process them in parallel, or on a time-share basis.

Similarly, it will be appreciated by those knowledgeable in the art that an apparatus in accordance with the principles of the claimed invention may include more than one output device 20. Although only one output device 20 is illustrated in FIG. 9, this configuration is exemplary only. A single first processor 18 may communicate with multiple output devices 20. For example, depending on the particular application, it may be advantageous for the processor 18 to communicate with a monitor for images, a database, a storage or recording device such as a hard drive or CD drive for storing images and/or processed data, and a printer such as a card printer for printing images and artifacts directly to “hard” media such as a printout or an identification card.

Likewise, additional output devices 20 may be connected with the second processor 19, or with both the first and second processors 18 and 19.

Alternatively, output devices need not necessarily output a portion of the images or artifacts generated by the apparatus 11. Rather, in some embodiments, it may be advantageous to output other information, such as the presence or number of artifacts identified, their time of arrival and departure, their speed, etc.

Optionally, an apparatus 11 in accordance with the principles of the claimed invention includes a backdrop 32. The backdrop 32 is adapted to provide a uniform, consistent background. The backdrop 32 is also adapted to block the field of view of the imager 12 from moving or changing objects or effects, including but not limited to other people, traffic, etc.

In a preferred embodiment, the backdrop 32 consists of a flat surface of uniform color, such as a piece of cloth. In a more preferred embodiment, the backdrop 32 has a color that contrasts strongly with colors commonly found in the subject 30 to be imaged. For human faces, this might include blue, green, or purple. However, this configuration is exemplary only, and backdrops that are textured, non-uniform, or do not contrast strongly may be equally suitable.

In another preferred embodiment, the backdrop 32 has a colored pattern thereon. For example, the pattern may be a regular, repeating sequence of small images such as a grid, or an arrangement of corporate logos. Alternatively, the pattern may be a single large image with internal color variations, such as a flag, mural, etc.

The use of a backdrop 32 is convenient, in that identification of a face is readily accomplished against a uniform, distinctly colored, and non-moving background. However, this is exemplary only, and it may be equally suitable to use a different backdrop 32.

Furthermore, it may be equally suitable to omit the backdrop 32 altogether. Thus, for certain applications it may be advantageous to have ordinary walls, furniture, etc. in the background. The use of a backdrop 32 is neither required nor excluded with the claimed invention.

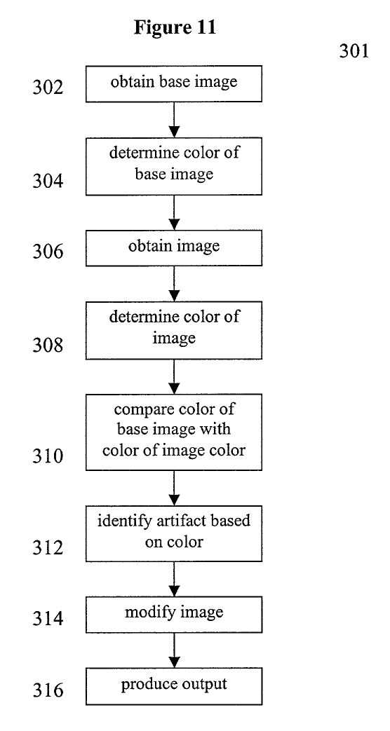

Referring to FIG. 11, a method of image evaluation 300 in accordance with the principles of the claimed invention includes the step of obtaining an image 306. Typically, the image includes a plurality of picture elements or pixels, each having a particular color. In a preferred embodiment, the image is in HSV format, so that each pixel has a color defined according to the HSV system (each pixel has a hue, a saturation, and a value).

The method 300 further includes the step of determining the color of the image 308. In this step, at least a portion of the image is evaluated to determine the color thereof. The details of how this is done may vary considerably from embodiment to embodiment.

For example, in images composed of pixels, it may be advantageous to identify the color of all the individual pixels in some part of the image, or in the entire image.

Alternatively, it may be advantageous to determine the color of representative samples of the image. For example, small groups of pixels spread across some or all of the image may be evaluated, or a particular portion of the image may be preferentially evaluated to determine its color.

Regardless of what portion or portions of the image are evaluated, the image may be evaluated in terms of the colors of individual pixels, or in terms of aggregate color values of groups of pixels.

A method of evaluating images 300 in accordance with the principles of the claimed invention also includes the step of identifying an artifact 312 in the image based at least in part on the color of the artifact and the remainder of the image.

Typically, the step of identifying the artifact based on color 312 utilizes algorithms for searching the image for regions of color that differ from the remainder of the image, and/or that match predetermined color criteria corresponding to the anticipated color of the artifact that is to be identified. For example, human faces, though variable in overall color, typically have a similar red content to their hue, and this may be used to distinguish them from a background.

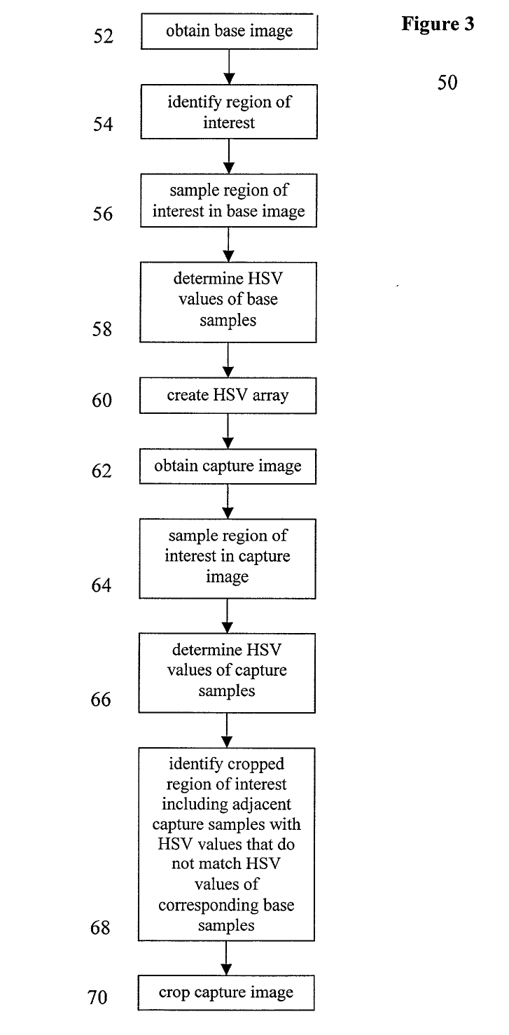

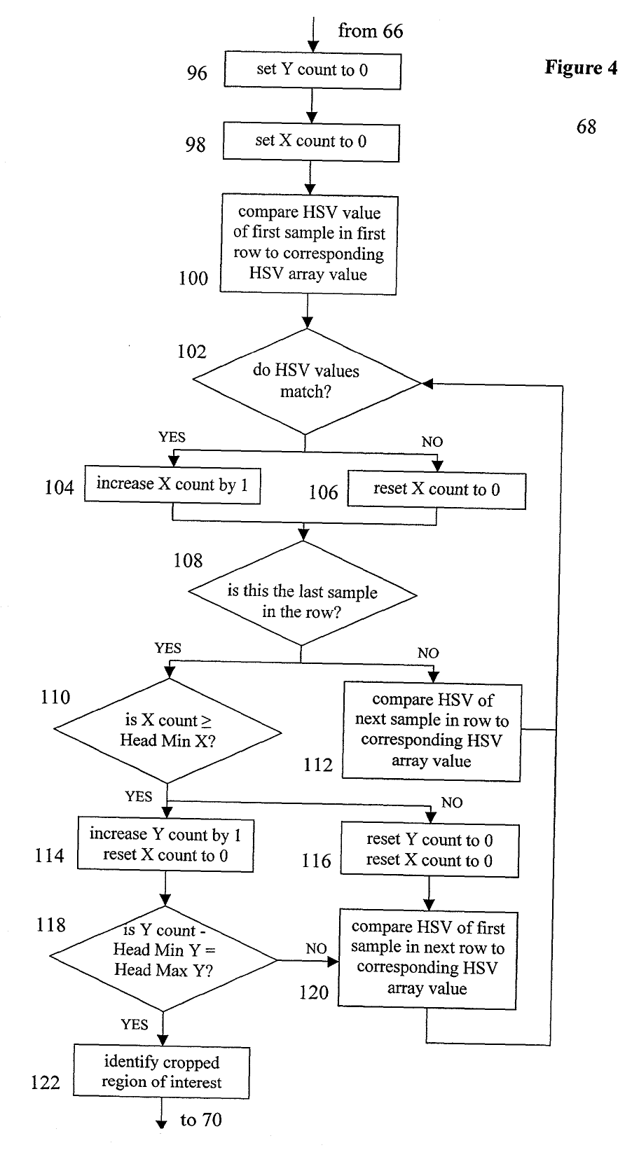

The precise algorithms suitable for identifying artifacts based on color 312 may vary substantially from embodiment to embodiment. An exemplary algorithm for the application of facial identification is described in greater detail below, with regard to FIGS. 3 and 4.

It is noted that color evaluation need not be limited to a simple search for a particular color or colors. Searches for ranges of colors, patterns within colors (i.e. an area of green within an area of red, or a white mark adjacent to a blue mark), gradual changes in colors, etc. may also be equally suitable for identifying artifacts based on color 312.

It is also noted that the identification of artifacts is not limited exclusively to identification based on color 312. Additional features may be relied upon, possibly utilizing additional algorithms. For example, with regard to facial identification, faces fall within a limited (if somewhat indefinite) range of sizes and shapes, i.e., faces are not two inches wide or two feet wide. Thus, geometrical properties may be utilized in identifying artifacts as well. The use of properties other than color, including but not limited to size, position, orientation, and motion, are neither required by nor excluded from the claimed invention.

As an optional step, a method of image evaluation 300 in accordance with the principles of the claimed invention may include modifying the image 314.

A wide variety of modifications may be suitable, depending upon the particular embodiment. For example, for certain embodiments, it may be desirable to crop an image so as to center it or otherwise align it within the image. It may be desirable to scale the image.

It may also be desirable to adjust the color of the artifact and/or the remainder of the image. For example, it may be desirable to adjust the hue, saturation, and/or value of the artifact in order to accommodate some standard color printing range, to produce standardized color output, or to correct for known color errors or variations. It may be desirable to adjust the color of the remainder of the image in a similar fashion.

Furthermore, it may be desirable for certain embodiments to modify the image 314 by removing the remainder of the image altogether. In the case of a facial image, for example, the background could be removed, so that the face may be easily distinguished if printed or otherwise displayed.

In addition, it may be desirable to replace the remainder of the image. Again with reference to a facial image, the background could be replaced with a standard image such as a graphical pattern, photograph, or corporate logo.

An exemplary method of image evaluation 300 in accordance with the principles of the claimed invention also includes the step of producing an output 316. As noted with regard to the apparatus 11, the range of suitable outputs is very large. Suitable outputs may include at least a portion of the artifact and/or the remainder of the image. Suitable outputs also may include information regarding the image without including the image itself. Suitable outputs include, but are not limited to, database entries, stored data, images displayed on a monitor, printed pages, and printed cards such as ID cards.

Another exemplary embodiment of a method of mage evaluation 301 in accordance with the principles of the claimed invention may include the use of a base image for comparison purposes, so as to further facilitate the identification of artifacts in the actual image. Such an arrangement is shown in FIG. 11.

In the method shown therein, a base image is obtained 302. The base image typically corresponds to a background without a subject present therein. For example, in the case of facial imaging, the base image may be obtained 302 without a person present.

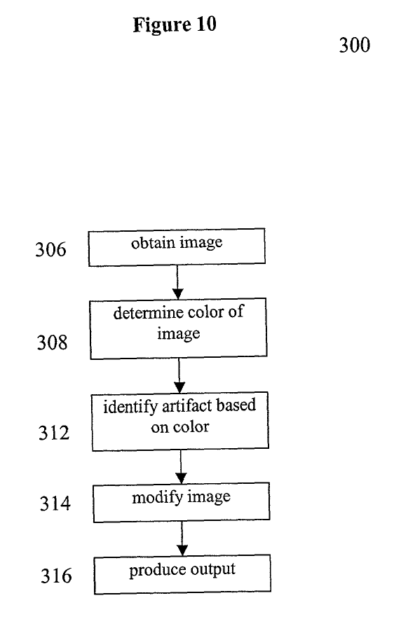

Next, the color of the base image is determined 304. This process is similar to the determination of the color of the image 308 as described above with respect to method 300 in FIG. 10, except that rather than using an image with an artifact therein, the base image is used. Although no artifacts are present, the color information that is present in the base image provides a comparison baseline for determining the presence of an artifact later on.

An image is then obtained 306, and the color of the image is determined 308, as described previously with regard to FIG. 10.

The color information from the base image, as determined in step 304, is then compared 310 with the color information from the image, as determined in step 308.

Typically, the step of comparing the color of the base image with the color of the image 310 utilizes algorithms for searching the image for regions having a color that differs from the color of similar regions in the base image.

The precise algorithms suitable for color comparison 310 may vary substantially from embodiment to embodiment. An exemplary algorithm for the application of facial identification is described in greater detail below, with regard to FIGS. 3 and 4.

Artifacts are then identified 312 in the image based at least in part on color. As described with regard to FIG. 10, the algorithms used for artifact identification 312 may vary. However, in addition to the search criteria described with respect to step 312 in FIG. 10, when a base image has been obtained 302 as shown in FIG. 11, artifact identification may also include distinguishing an artifact from a remainder of the image based on the color differences between the base image and the image with the artifact therein.

For example, with regard to facial imaging, if a base image does not show a face, and the image under consideration does show a face, there will be a portion of the base image that has different coloration than that same portion in the image under consideration.

Again, the precise algorithms suitable for identifying artifacts based on color 312 may vary substantially from embodiment to embodiment. An exemplary algorithm for the application of facial identification is described in greater detail below, with regard to FIGS. 3 and 4.

As an optional step, the image may be modified 314 as described above with regard to FIG. 10.

Likewise, an output is produced 316 as described above with regard to FIG. 10.

In a preferred embodiment of the method 300 or 301, the method may be at least partially automated. That is, the some or all of the steps therein may be performed automatically, without the need for direct intervention by an operator.

Likewise, a preferred embodiment of the apparatus 11 may be at least partially automated, so that the components are functional without direct intervention.

For example, an apparatus 11 similar to that shown in FIG. 9 may be automated, such that once it is activated, the second imager 13 automatically monitors for a subject 30. When a subject 30 enters the field of view of the second imager 13, the second processor 19 automatically identifies a first artifact in the second image corresponding to the subject 30, and automatically signals the first imager 12 to generate a first image. The first processor 18 then automatically identifies a first artifact in the first image, and the output device 20 then automatically produces an output.

In such an arrangement, for example as used for an exemplary application of producing ID cards, the process, once initiated, does not require an operator. Since, as noted above, the apparatus may be adapted to identify when a the second artifact is no longer present in the second image (i.e. when person exits the field of view), the apparatus 11 may be used to generate repeated outputs, one for each time a new person enters the field of view of the imagers 12 and 13.

For purposes of providing a more concrete and less general example of a method and apparatus in accordance with the principles of the claimed invention, a method and apparatus are now described in detail with regard to the particular application of facial imaging.

However, it is emphasized that this application, and the embodiments described with respect thereto, are exemplary only. Other embodiments and applications may be equally suitable.

It is noted that many of the elements shown in FIG. 2, and described as components of an apparatus for cropping images 10, are essentially similar to those elements described in FIG. 9 for a more generalized image evaluating apparatus 11. Where this is the case, the same element numbers are used. Further information regarding the individual elements is provided below.

Referring to FIG. 2, an apparatus for cropping images 10 in accordance with the principles of the claimed invention includes first imager 12. In a preferred embodiment of the apparatus, the first imager is a conventional video camera that generates video images. In another preferred embodiment of the apparatus, the first imager is a conventional digital still camera that generates digital still images.

It is convenient if the first imager is a digital imager, in that it enables easy communication with common electronic components. However, this choice is exemplary only, and a variety of alternative first imagers, including but not limited to analog imagers, may be equally suitable. Suitable imagers are well known, and are not further described herein.

In a preferred embodiment, the first imager 12 generates images that are in HSV (hue-saturation-value) format. This is convenient for at least the reason that HSV format is insensitive to variations in ambient lighting. This avoids a need for frequent recalibration and/or color correction of the first imager 12 as lighting conditions vary over time (as with changes in the intensity and direction of daylight). However, this is exemplary only, and the first imager 12 may generate images in formats other than HSV, including but not limited to RGB. The HSV format is well known, and is not further described herein.

The first imager 12 is in communication with a first processor 18. The first processor 18 is adapted identify that portion of an image that shows a face within an image containing a face. In particular, the first processor 18 is adapted to identify sample areas, to determine the color value of sample areas in HSV format, to generate an array of HSV values, and to compare HSV values to one another. In a preferred embodiment, the first processor 18 consists of digital logic circuits assembled on one or more integrated circuit chips or boards. Integrated circuit chips and boards are well-known, and are not further discussed herein. In a more preferred embodiment, the first processor 18 consists of a commercial microcomputer. This is advantageous, for at least the reason that microcomputers are readily available and inexpensive. However, this choice is exemplary only, and other processors, including but not limited to dedicated integrated circuit systems, may be equally suitable.

The first processor 18 is in communication with at least one output device 20. A variety of output devices 20 may be suitable for communication with the first processor 18, including but not limited to video monitors, hard drives, and card printers. Output devices are well-known, and are not further discussed herein.

In an alternative preferred embodiment, the first imager 12 generates images that are not in HSV format, and the apparatus 10 includes a first HSV converter 14 in communication with the first imager 12 and the first processor 18 for converting images from a non-HSV format to HSV format. In a preferred embodiment, the first HSV converter 14 may consist of hardware or software integral to the first processor 18. This is convenient, in that it avoids the need for an additional separate component. However, this choice is exemplary only, and other first HSV converters 14, including but not limited to separate, dedicated systems, may be equally suitable. HSV converters are well known, and are not further described herein.

In an additional alternative embodiment, the first imager 12 generates non-digital images, and the apparatus 10 includes a first digitizer 16 in communication with the first imager 12 and the first processor 18 for converting images from a non-digital format to digital format. In a preferred embodiment, the first digitizer 16 may consist of hardware or software integral to the first processor 18. This is convenient, in that it avoids the need for an additional separate component. However, this choice is exemplary only, and other first digitizers 16, including but not limited to separate, dedicated systems, may be equally suitable. Digitizers are well known, and are not further described herein.

It will be appreciated by those knowledgeable in the art that the although the first imager 12 by necessity must be located such that its field of view includes a subject 30 to be imaged, the first processor 18, the output device 20, and the optional first HSV converter 14 and first digitizer 16 may be remote from the first imager 12 and/or from one another. As illustrated in FIG. 2, these components appear proximate one another. However, in an exemplary embodiment, the first imager 12 could be placed near the subject 30, with some or all of the remaining components being located some distance away. For example, for certain applications, it may be advantageous to connect the first imager to a network that includes the first processor 18 and the output device 20. Alternatively, some available first imagers 12 include internal memory systems for storing images, and thus need not be continuously in communication with the first processor 18 and the output device 20. In such circumstances, the first imager 12 may be an arbitrary distance from the other components of the apparatus 10.

In addition, it is noted that although the elements illustrated in FIG. 2 are shown to be connected, it is not necessary that they be connected physically. Rather, they must be in communication with one another as shown. In particular, wireless methods of communication, which do not require any physical connections, may be suitable with the claimed invention.

An apparatus in accordance with the principles of the claimed invention may include more than one first imager 12. Although only one first imager 12 is illustrated in FIG. 2, this configuration is exemplary only. A single first processor 18 and the output device 20 may operate in conjunction with multiple first imagers 12. Depending on the particular application, it may be advantageous for example to switch between imaging devices 12, or to process images from multiple imaging devices 12 in sequence, or to process them in parallel, or on a time-share basis.

Similarly, an apparatus in accordance with the principles of the claimed invention may include more than one output device 20. Although only one output device 20 is illustrated in FIG. 2, this configuration is exemplary only. A single first processor 18 may communicate with multiple output devices 20. For example, depending on the particular application, it may be advantageous for the first processor 18 to communicate with a video monitor for viewing of cropped and/or uncropped images, a storage device such as a hard drive or CD drive for storing images and/or processed data, and a card printer for printing cropped images directly to identification cards.

Optionally, an apparatus 10 in accordance with the principles of the claimed invention includes a backdrop 32. The backdrop 32 is adapted to provide a uniform, consistent background. The backdrop 32 is also adapted to block the field of view of the first imager 12 from moving or changing objects or effects, including but not limited to other people, traffic, etc.

In a preferred embodiment, the backdrop 32 consists of a flat surface of uniform color, such as a piece of cloth. In a more preferred embodiment, the backdrop 32 has a color that contrasts strongly with colors commonly found in human faces, such as blue, green, or purple. However, this configuration is exemplary only, and backdrops that are textured, non-uniform, or do not contrast strongly may be equally suitable.

In another preferred embodiment, the backdrop 32 has a colored pattern thereon. For example, the pattern may be a regular, repeating sequence of small images such as a grid, or an arrangement of corporate logos. Alternatively, the pattern may be a single large image with internal color variations, such as a flag, mural, etc.

The use of a backdrop is convenient, in that identification of a face is readily accomplished against a uniform, distinctly colored, and non-moving background. However, this is exemplary only, and it may be equally suitable to use a different backdrop.

Furthermore, it may be equally suitable to omit the backdrop altogether. Thus, for certain applications it may be advantageous to have ordinary walls, furniture, etc. in the background.

Referring to FIG. 3, a method of cropping images 50 in accordance with the principles of the claimed invention includes the step of obtaining a digital base image 52. The base image is used to generate baseline information regarding background conditions, and does not include a human subject. However, the base image includes the area wherein the human subject is anticipated to be when he or she is subsequently imaged. The base image includes a plurality of pixels.

It is noted that, in embodiments wherein the first imager 12 is a video imager, the base image may be obtained 52 as a captured still image. Likewise, the capture image may be obtained 62 as a captured still image. Capturing images and devices for capturing images are well known, and are not described further herein.

In addition, it is emphasized that while FIG. 9 (described previously) shows an embodiment having two imagers and two processors, as shown in FIG. 2 and described therein it may also be suitable to utilize only a single imager and a single processor.

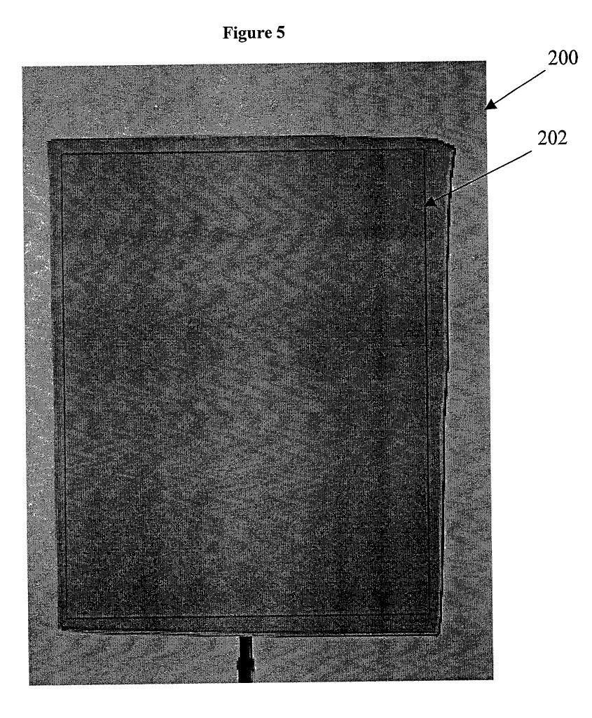

A method 50 in accordance with the principles of the claimed invention also includes the step of identifying an area of interest 54. The region of interest is that portion of the images to be taken that is to be processed using the method of the claimed invention. As such, it is chosen with a size, shape, and location such that it includes the likely area of subjects' faces, so as to be of best use in obtaining clear facial images. An exemplary base image 200 is illustrated in FIG. 5, with an exemplary region of interest 202 marked thereon. It is noted that in actual application, although the region of interest 202 must be identified, and information retained, the region of interest 202 need not be continuously indicated visually as in FIG. 5. It will be appreciated by those knowledgeable in the art that the base image 200 and the region of interest 202 are exemplary only. It will also be appreciated by those knowledgeable in the art that the area of interest 202 may be substantially larger than the total area of a single face, so as to accommodate variations in the height of different subjects, various positions (i.e. sitting or standing), etc.

Identifying the region of interest 54 may be done in an essentially arbitrary manner, as it is a convenience for data handling. Returning to FIG. 3, in a preferred embodiment of a method in accordance with the principles of the claimed invention, identification of the region of interest 54 is performed by selecting a portion of the base image, for example with a mouse, as it is displayed on a video screen. However, this is exemplary only, and other methods for identifying a region of interest may be equally suitable.

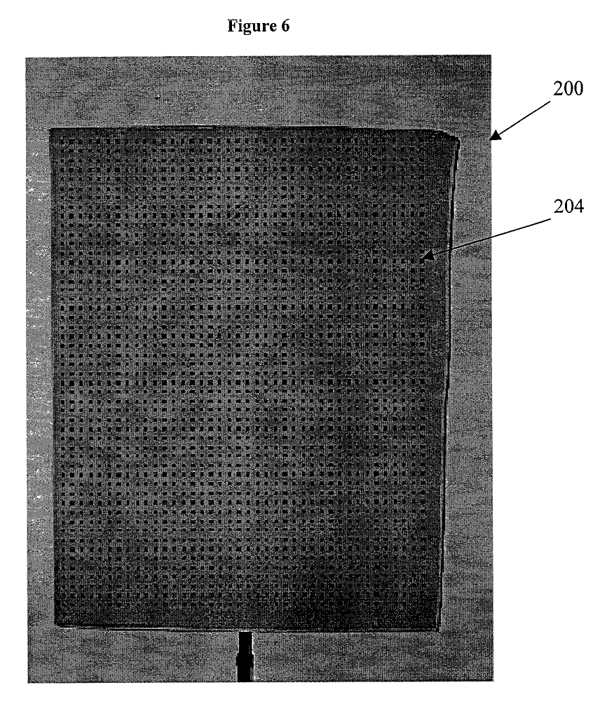

A method of cropping images 50 in accordance with the principles of the claimed invention includes the step of sampling the region of interest in the base image 56. A plurality of base samples are identified in the base image, the base samples then being used for further analysis. A wide variety of base sample sizes, locations, numbers, and distributions may be suitable. An exemplary plurality of base samples 204 is illustrated in FIG. 6, as distributed across the base image 200 illustrated in FIG. 5.

In a preferred embodiment of the claimed invention, each of the base samples 204 includes at least two pixels. This is convenient, in that it helps to avoid erroneous differences in apparent color caused by variations in pixel sensitivity, single-bit data errors, debris on the lens of the first imager 12, etc. In addition, having two or more pixels in each sample facilitates identification of color patterns if the background, and hence the base image and the non-facial area of the capture image, are not of uniform color. However, this is exemplary only, and for certain applications using only one pixel per sample may be equally suitable.

Also in a preferred embodiment of the claimed invention, the base samples 204 include only a portion of the region of interest 202. This is convenient, in that it reduces the total amount of processing necessary to implement a method in accordance with the principles of the claimed invention. However, this is exemplary only, and base samples 204 may be arranged so as to include the entirety of the region of interest 202.

Additionally, in a preferred embodiment of the claimed invention, the base samples 204 are distributed along a regular Cartesian grid, in vertical and horizontal rows. This is convenient, in that it provides a distribution of base samples 204 that is readily understandable to an operator and is easily adapted to certain computations. However, this distribution is exemplary only, and other distributions of base samples 204, including but not limited to hexagonal and polar, may be equally suitable.

A method 50 in accordance with the principles of the claimed invention further includes the step of determining an HSV value for each base sample 58 in the base image. In a preferred embodiment, the HSV value for a base sample 204 is equal to the average of the HSV values of the pixels making up that sample. This is mathematically convenient, and produces a simple, aggregate color value for the sample. However, this is exemplary only, and other approaches for determining an HSV value for the base samples 204 may be equally suitable.

Next, an HSV array is created 60 that consists of the HSV values for each of the base samples 204 from the base image 200. These data are retained for use comparison purposes. In a preferred embodiment of the claimed invention, the array is defined with a first dimension equal to the number of columns of base samples in the region of interest, and a second dimension equal to the number of rows of base samples in the region of interest. This is convenient, in particular if the base samples 204 are distributed along a Cartesian grid, because such an array is readily understandable to an operator and is easily adapted to certain computations. However, this form for the array is exemplary only, and other arrays of HSV values, including but not limited to arrays that match the geometry of hexagonal and polar sample distributions, may be equally suitable.

A method of cropping images 50 in accordance with the principles of the claimed invention includes the step of obtaining a digital capture image 62. The capture image is an image of a subject, including the subject's face. The capture image includes a plurality of pixels. FIG. 6 illustrates an exemplary capture image 206.

In a preferred embodiment of the claimed invention, the capture image 206 is an image with essentially the same properties as the base image 200, with the exception of the presence of a subject in the capture image, wherein the capture image 206 is taken from exactly the same distance and direction as the base image 200. However, this is exemplary only, and a capture image 206 taken at a slightly different distance and direction may be equally suitable.

Also in a preferred embodiment of the claimed invention, the capture image 206 contains the same number of pixels, and has the same width and height and the same aspect ratio as the base image 200. However, this is exemplary only, and a capture image 206 may have a different total number of pixels, width, height, and aspect ratio than the base image, so long as the region of interest 202 is substantially similar in both the base and the capture images 200 and 206.

Returning to FIG. 3, a method of cropping images 50 in accordance with the principles of the claimed invention includes the step of sampling the region of interest in the capture image 64. A plurality of capture samples 208 is identified in the capture image, each of the capture samples 208 corresponding approximately in terms of size and spatial location with one of the base samples 204.

An exemplary plurality of capture samples 208 is illustrated in FIG. 6, distributed across the capture image 206 as the base samples 204 are distributed across the base image 200 illustrated in FIG. 5.

It is preferable that the pixels of the capture image 206 correspond exactly, one-for-one, with the pixels of the capture image 200. This is convenient, in that it enables a highly accurate match between the base and capture images 200 and 206. However, this is exemplary only, and because corresponding base and capture samples 204 and 208 rather than corresponding pixels are used to identify the face and crop the capture image 206, so long as the base and capture samples 204 and 208 occupy approximately the same area and spatial location, it is not necessary that the pixels themselves correspond perfectly.

It is likewise preferable that the base and capture samples 204 and 208 correspond exactly, pixel-for-pixel. This is convenient, in that it enables a highly accurate match between the base and capture samples 204 and 208. However, this is exemplary only, and because aggregate color values for the samples rather than values for individual pixels are used to identify the face and crop the capture image 206, so long as the base and capture samples 204 and 208 incorporate approximately the same pixels, it is not necessary that they match perfectly.

Returning again to FIG. 3, the HSV values of each of the capture samples is determined. In a preferred embodiment, the HSV value for a capture sample 208 is equal to the average of the HSV values of the pixels making up that capture sample. This is mathematically convenient, and produces a simple, aggregate color value for the capture sample. However, this is exemplary only, and other approaches for determining an HSV value for the capture samples 208 may be equally suitable.

Also in a preferred embodiment, the algorithm for determining the HSV value for each of the capture samples 208 is the same as the algorithm for determining the HSV value for each of the base samples 204. This is convenient, in that it allows for consistent and comparable values for the base and capture samples 204 and 208. However, this is exemplary only, and is may be equally suitable to use different algorithms for determining the HSV values for the capture samples 208 than for the base samples 204.

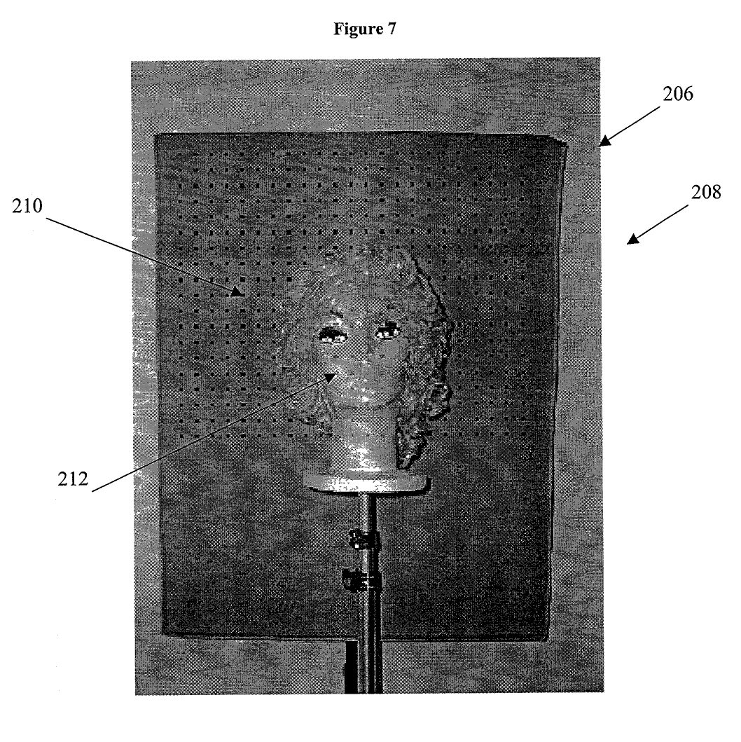

Adjacent capture samples with HSV values that do not match the HSV values of their corresponding base samples are then identified 68. As may be seen in FIG. 7, adjacent capture samples meeting this criterion are assembled into a crop region of interest 214. The crop region of interest 214 corresponds approximately to the subject's face.

The algorithm used to determine whether a particular capture sample 208 is or is not part of the crop region of interest 214 may vary considerably. The following description relates to an exemplary algorithm. However, other algorithms may be equally suitable. In particular, it is noted that, in the following description, for purposes of clarity it is assumed that the base and capture samples 204 and 208 are in a Cartesian distribution. However, as previously pointed out, this is exemplary only, and a variety of other distributions may be equally suitable.

Referring to FIG. 4, in an exemplary embodiment of a method in accordance with the principles of the claimed invention, the step of identifying the crop region of interest 68 includes the step of setting a first latch, also referred to herein as an X Count, to 0 96. This exemplary method also includes the step of setting a second latch, also referred to herein as a Y Count, to 0 98.

The exemplary method includes the step of comparing the HSV value of the leftmost capture sample in the topmost row of capture samples to the HSV value for the corresponding base sample 100. For reference purposes, the position of a sample within row is referred to herein as the X position, the leftmost position being considered 0. Similarly, the position of a row within the distribution of samples is referred to herein as the Y position, the topmost position being considered 0. As so referenced, this step 100 is thus a comparison of the HSV value of capture sample (0,0) with base sample (0,0).

It is determined whether the aforementioned HSV values match 102 to within at least one match parameter. The match parameters are measures of the differences in color between the capture and base samples. The precise values of the match parameters may vary depending on camera properties, the desired degree of sensitivity of the system, ambient coloration of the background, etc. The match parameters should be sufficiently narrow that a change from background color to another color, indicating the presence of a portion of the subject's face in a sample under consideration, is reliably detected. However, the match parameter should also be sufficiently broad that minor variations in background coloration will not cause erroneous indications of a face where a face is not present.

It will be appreciated that a variety of ways for setting the at least one match parameter may be suitable. In one preferred embodiment, the at least one match parameter is set manually by an operator. This is convenient, in that it is simple, and enables a user to correct for known imaging properties of the background and or images.

However, in another preferred embodiment, the at least one match parameter is determined automatically as a function of the natural color variation of the base samples. This is also convenient, in that it enables the at least one match parameters to set themselves based on existing conditions.

In yet another preferred embodiment, the at least one match parameter includes pattern recognition information. This is convenient, in that it facilitates use of the method under conditions where the background is not uniform, for example, wherein images are obtained against an ordinary wall, a normal room, or against a patterned backdrop.

In still another preferred embodiment, the at least one match parameter includes pattern information and is also determined automatically as a function of the natural color variation of the base samples. This is convenient, in that it enables the pattern to be “learned”. That is, base sample data may be used to automatically determine the location of the subject with regard to the known background based on the color patterns present in the background. Minor alterations in the background could therefore be ignored, as well as variations in perspective. Thus, it would not be necessary to take capture images from the same distance and direction from the subject as the base image, or to take all capture images from the same distance and direction as one another. Furthermore, multiple cameras could be used, with different imaging properties.

The foregoing discussion of match parameters is exemplary only, and a wide variety of other match parameters may be equally suitable.

If the HSV values of the base and capture samples match to within the match parameter, the X count is increased by 1 104. If the HSV values of the base and capture samples do not match to within the match parameter, the X count is reset to 0 106. The X count in this exemplary embodiment is a measure of the number of consecutive, and hence adjacent, capture samples that are different in color from their corresponding base samples.

For purposes of illustration, FIG. 7 illustrates capture samples 208 following comparison with their corresponding base samples 204. As identified therein, capture samples that match their corresponding base samples are indicated as element 210, while capture samples that do not match their corresponding base samples are indicated as element 212. It is noted that in actual application, although individual capture samples 208 are identified as either those that do match 210 or those that do not match 212, this information need not be continuously indicated visually as in FIG. 7.

Returning to FIG. 4, it is determined whether the capture sample just compared is the last capture sample in its row 108.

If it is not the last capture sample in its row, the HSV value of the next capture sample in the row is compared to the HSV value of its corresponding base sample 112. The exemplary method then continues with step 102.

If the capture sample just compared is the last capture sample in its row, it is determined whether the current X count is greater than or equal to a minimum X count corresponding to a head width 110. This minimum X count is also referred to herein as Head Min X. Head Min X represents the minimum anticipated width of a subject's head in terms of the number of consecutive capture samples that differ in HSV value from their corresponding base samples. A value for Head Min X may vary depending on the desired level of sensitivity, the size and distribution of samples within the region of interest, the camera properties, etc. Evaluating whether the X count is greater than or equal to the Head Min X is useful, in that it may eliminate errors due to localized variations in background that are not actually part of the subject's face.

If the X count is not equal to or greater than Head Min X, the Y count is reset to 0, and the X count is reset to 0 116. The HSV value of the first capture sample in the next row is then compared to the HSV value of its corresponding base sample 120. The exemplary method then continues with step 102

If the X count is equal to or greater than Head Min X, the Y count is increased by 1, and the X count is reset to 0 114. The Y count in this exemplary embodiment is a measure of the number of consecutive, and hence adjacent, rows of capture samples that are different in color from their corresponding base samples.

Subsequent to step 114, it is determined whether the Y count is equal to a minimum Y count corresponding to a head height minus a cutoff Y count related to a maximum scan height 118. The minimum Y count is also referred to herein as Head Min Y.

Head Min Y represents the minimum anticipated height of a subject's head in terms of the number of consecutive rows of capture samples wherein each row has at least Head Min X adjacent capture samples therein that differ in HSV value from their corresponding base samples. A value for Head Min Y may vary depending on the desired level of sensitivity, the size and distribution of samples within the region of interest, the camera properties, etc.

Cutoff Y represents a maximum height beyond that which represents the minimum height of a subject's face that is to be included within a final cropped image. Given a region of interest that may be substantially larger than any one face, so as to accommodate various heights, etc., a capture image may include a substantial portion of the subject beyond merely his or her face. In order to crop an image so that it shows substantially only the subject's face, it is useful to limit how much of the subject is included in the cropped image. It is convenient to do this by limiting sampling in a downward direction. A value for Head Min Y may vary depending on the size and distribution of samples within the region of interest, the camera properties, the desired portion of the subject's face and/or body to be included in a cropped image, etc.

Determining whether the Y count equals Head Min Y—cutoff Y 118 provides a convenient test to determine both whether the height of the current number of rows of adjacent capture samples that differ in HSV value from their corresponding base samples is sufficient to include a face, and simultaneously whether it is so large as to include more of the subject than is desired (i.e., more than just the face).

If the Y count equals Head Min Y—cutoff Y, sample comparison stops, and a crop region of interest is identified 122.

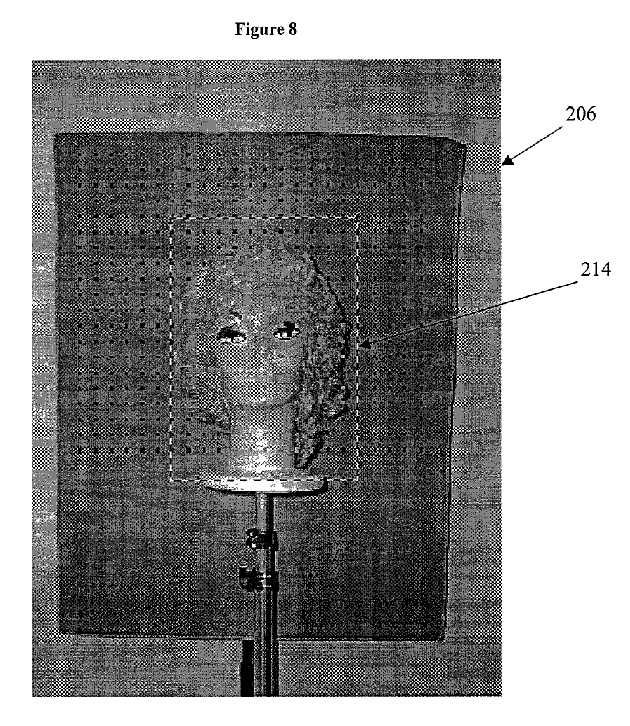

An exemplary crop region of interest 214 is illustrated in FIG. 8. As may be seen therein, this exemplary crop region of interest 214 includes all of the adjacent capture samples that differ in HSV value from their corresponding base samples. In addition, this exemplary crop region of interest 214 includes margins above and below the adjacent capture samples that differ in HSV value from their corresponding base samples. These attributes are exemplary only. For certain applications, it may be desirable to limit a crop region of interest to a particular pixel width, or to a particular aspect ratio, regardless of the width of the capture image represented by the adjacent capture samples that differ in HSV value from their corresponding base samples. Likewise, it may be desirable to include margins on the left and/or right sides, or to omit margins entirely, for example by scaling the portion of the capture image represented by the adjacent capture samples that differ in HSV value from their corresponding base samples so that it reaches entirely to the edges of the available image space on an ID card.

It is emphasized that the above disclosed algorithm for identifying a crop region of interest is exemplary only, as was previously noted, and that a variety of other algorithms may be equally suitable.

Returning to FIG. 4, once a crop region of interest is identified 122 the method continues at step 70.

In an exemplary embodiment of a method in accordance with the principles of the claimed invention, once a crop region of interest is identified 68, the capture image is cropped 70. A variety of techniques for determining the precise location of cropping based on the crop region of interest may be suitable.

For example, the center of the crop region of interest may be identified, and the capture image may then be cropped at particular distances from the center.

Alternatively, a particular cropped image width and cropped image aspect ratio may be identified or input by an operator, and the capture image may then be cropped to that size.

Additionally, the copped image may be scaled in conjunction with cropping, for example so as to fit a particular window of available space on an identification card.

It will be appreciated that the cropped image may be output for a variety of uses and to a variety of devices and locations. This includes, but is not limited to, printing of the cropped image on an identification card.

In some embodiments of an apparatus and method in accordance with the claimed invention, some or all of the parameters disclosed herein may be adjustable by an operator. This includes but is not limited to the region of interest, the distribution of samples, the size of samples, the match parameter, and the presence or absence of scaling and/or margins with respect to the crop region of interest.

Furthermore, as stated previously, the embodiments of the apparatus and method described above with regard to image cropping and facial imaging are exemplary only, and are provided for clarity. The claimed invention is not limited to those embodiments or applications.

The above specification, examples and data provide a complete description of the manufacture and use of the composition of the invention. Since many embodiments of the invention can be made without departing from the spirit and scope of the invention, the invention resides in the claims hereinafter appended.

1. Method of image evaluation, comprising the steps of:
obtaining an image in HSV format;
automatically determining a color of at least a portion of said image;
automatically identifying an artifact in said image based at least in part on a color of said artifact and a color of a remainder of said image;
producing an output based on the artifact.

2. Method according to claim 1, further comprising the step of:
automatically modifying at least a portion of said image after identifying said artifact and prior to producing said output;
wherein said output comprises at least a portion of said artifact.

3. Method according to claim 2, wherein:
modifying said image comprises cropping said image.

4. Method according to claim 2, wherein:
modifying said image comprises scaling said image.

5. Method according to claim 2, wherein:
modifying said image comprises adjusting a color of said artifact.

6. Method according to claim 2, wherein:
modifying said image comprises adjusting a color of said remainder.

7. Method according to claim 2, wherein:
modifying said image comprises adjusting an orientation of said image.

8. Method according to claim 2, wherein:
modifying said image comprises replacing said remainder.

9 Method according to claim 2, wherein:
modifying said image comprises removing said remainder.

10. Method according to claim 1, wherein:
said output comprises information regarding the artifact.

11. Method according to claim 1, wherein:
said output comprises an instruction for obtaining further images.

12. Method according to claim 11, wherein:
said instruction comprises at least one of the group consisting of a focus instruction, an alignment instruction, a color balance instruction, a magnification instruction, and an orientation instruction.

13. Method according to claim 1, further comprising the steps of:
obtaining a base image in HSV format;
automatically determining a color of at least a portion of said base image;
automatically comparing said color of at least a portion of said base image to said color of at least a portion of said image;
automatically identifying said artifact in said image based at least in part on a color of said base image.

14. Apparatus for image processing, comprising:
a first imager adapted to generate a color first image in HSV format;
a first processor in communication with first said imager, said first processor being adapted to automatically distinguish a first artifact in the first image from a remainder of the first image based at least in part on a color of said first artifact and a color of a remainder of said first image;
an output device in communication with said first processor, said output device being adapted to generate an output based on said first artifact.

15. Apparatus according to claim 14, wherein:
the first imager is a video imager, and the first image is a video image.

16. Apparatus according to claim 14, wherein:
the output comprises at least a portion of the first artifact.

17. Apparatus according to claim 14, further comprising:
a second imager adapted to generate a color second image in HSV format; and
a second processor in communication with said first and second imagers;
wherein
said first imager is a still imager, and the first image is a still image;
said second imager is a video imager, and the second image is a video image;
said second processor is adapted to automatically distinguish a second artifact in the second image from a remainder of the second image based at least in part on a color of said second artifact and a color of a remainder of said second image; and
said second processor is adapted to signal said first imager to generate the first image when said second processor has distinguished the second artifact.

18. Apparatus according to claim 17, wherein:
said second imager and said second processor comprise an integral unit.

19. Apparatus according to claim 17, wherein:
said first processor comprises a personal computer.

20. Apparatus according to claim 17, wherein:
said second imager comprises a digital video camera.

21. Apparatus according to claim 17, wherein:
said first imager comprises a digital still camera.

22. Apparatus according to claim 17, wherein:
said first processor is not adapted to receive the second image

23. Apparatus according to claim 14, wherein:
said output apparatus comprises a database.

24. Apparatus according to claim 14, wherein:
said output apparatus comprises a video display.

25. Apparatus according to claim 14, wherein:
said output apparatus comprises a printer.

26. Apparatus according to claim 14, wherein:
said output apparatus comprises card printer.

27. Apparatus according to claim 14, wherein:
said output apparatus comprises a recording device.
